(19) United States
(12) Patent Application Publication
(10) Pub. No.: US 2006/0249255 A1
(43) Pub. Date: Nov. 9, 2006

(54) Adhesive laminating apparatus and a printing apparatus with the adhesive laminating function

(75) Inventors: Kuo-Hung Lin, Taipei Hsien (TW); Yu-Hua Chen, Taipei Hsien (TW); Chien-Hsing Huang, Taipei Hsien (TW)

Correspondence Address: BRUCE H. TROXELL;SUITE 1404, 5205 LEESBURG PIKE, FALLS CHURCH, VA, 22041, US

(73) Assignee: KINPO ELECTRONICS, INC.

(21) Appl. No.: 11/477,610

(22) Filed: Jun. 30, 2006

(30) Foreign Application Priority Data
Apr. 7, 2005 (TW) 094122538
Apr. 7, 2005 (TW) 094122540

(51) Int. Cl. B32B 37/00; B32B 38/04; B32B 41/00; B32B 38/14

(52) U.S. Cl. 156/353; 156/387; 156/522; 156/552

(57) ABSTRACT

An adhesive laminating apparatus comprises a rack which connected to a sensor, two gluey-film rollers, a feeding-in roller set, a movable cutlery set, a feeding-out roller set and a controller etc. in sequence. Documents which are ready to laminate are automatically cohered between two gluey-films like a sandwich. It causes the movable cutlery set to cut a laminated gluey-film, and then laminated documents are sent out of the roller set.

### BACKGROUND OF THE INVENTION

1. Field of the Invention

The present invention relates to a printer and an adhesive laminating apparatus, especially as it relates to a structure of improving an adhesive laminating apparatus. It integrates an adhesive laminating function used for a printer.

2. Brief Description of Related Art

There is such a wide range of printer types, such as a laser printer, an ink printer and a photo printer, and each has its own function. If we want to laminate all printed documents and photo pictures, the laminating process has to be carried out by using an adhesive laminating apparatus.

For example, Taiwan Utility Pat. No. 247389 disclosed an adhesive laminating apparatus for improving thermal management. First, it places the document to be laminated between two sheets of laminating film, then the rollers are heated internally by using the adhesive laminating apparatus with a preheating device, and then using these two rollers to press from both sides, applying heat and pressure to the laminating film and thus finishes the laminating process.

Taiwan Pat. No. 248749 disclosed a simple structure for a cold laminating film. Upper films and bottoms film are made of polyester. The major characteristic of this patent is the upper film is spread inside with adhesives, and also applies a suitable adhesiveness to one side of the upper film and bottom film. It uses a from-the paper to glue upper films inside together in advance. This from-the paper is used for isolating the sticky glue from the upper film and bottom film. When the document is placed between opposing upper film and bottom film, then the from-the paper is torn. It causes the document to place between the opposing bottom layers, by means of a simplified process for rolling; then causes the upper film and bottom film to be wrapped onto the opposing surface of documents.

The above-mentioned adhesive laminating apparatus with a thermal device, it needs a preheated process to carry out the laminating operation. Disadvantages: It is time consuming to wait an indefinite period of time for preheating, and the laminating effect may not be well controlled, a burning problem is caused by a careless user. The above-mentioned thermal adhesive laminating apparatus when carried out by a laminating process which uses a cold laminating film, laminated documents are adjusted into a fixed size manually, and are placed between opposing upper and bottom laminating films then it carries out the laminating operation. It not only wastes manpower but also is unable to laminate the document automatically. Also, because the laminating film which is fixed in a size and which also wastes a whole laminating film even if a small document is to be laminated; when documents are larger than the items being laminated, it is unable to carry out the lamination of an adhesive laminating apparatus.

### SUMMARY OF THE INVENTION

The present invention is to provide an improved an adhesive laminating apparatus that avoids the disadvantages of the prior art and concurrently integrates the adhesive laminating function used for a printer.

The main object of the present invention is to provide an adhesive laminating apparatus for automatically laminating documents and improve the efficiency of a laminating operation.

Another object of the present invention is to provide an adhesive laminating apparatus for unifying the effect of a laminating operation and have a safe operation.

The other object of the present invention is to provide an adhesive laminating apparatus for automatically adjusting the cutting length of the laminating film which is coordinated with the length of the document, thus reducing waste produced from the unused laminating films.

Another object of the present invention is to provide an integrated laminating function used for a printer which is capable of automatically laminating documents, and increase the practical function for a printer.

Another object of the present invention is to provide a printing apparatus with the adhesive laminating function, which is capable of unifying the effect of a laminating operation and having a safe operation.

Another object of the present invention is to provide a printing apparatus with the adhesive laminating function, which can automatically adjust cutting the length of the laminating film that is coordinated with the length of the document, thus reducing waste produced form the unused laminating films.

Further features and other objects of the present invention will become apparent from the following detailed description, taken in conjunction with the drawings and embodiments.

### BRIEF DESCRIPTION OF THE DRAWINGS

FIG. 1 is a schematic diagram of a printing apparatus with the adhesive laminating function in accordance with the present invention.

FIG. 2 is a schematic diagram of an adhesive laminating film in accordance with the present invention.

### DETAILED DESCRIPTION OF THE INVENTION

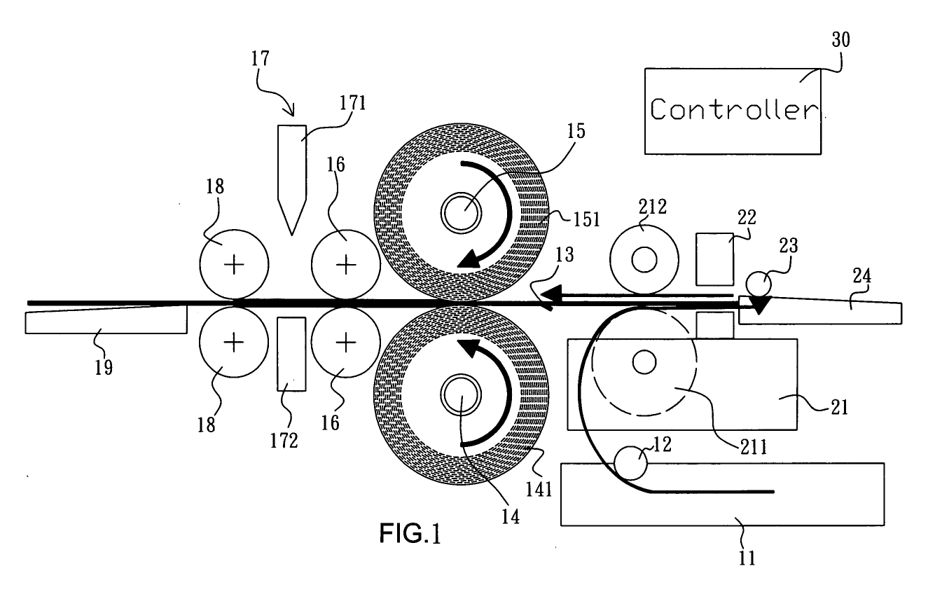

Pleases refer to FIG. 1, the present invention is provided with a printing apparatus with the adhesive laminating function. This printing apparatus comprises a rack which connecting with a carrying tray 11, a first output roller 12, a feed roller 211, a pinch roller 212, a printing head 22, a second output roller 23, a first tray 24, a sensor 13, two gluey-film rollers 14, 15, a feed-in roller set 16, a movable cutlery set 17, a feed-out roller set 18, a second tray 19 and a controller 30. The carrying tray 11 may contain documents, photos, laminated sheets and such things that are to be printed. The first output roller 12 is coordinated with the carrying tray 11. When the first roller 12 is in operation, documents can be fed out from the carrying tray 11, fed into the feeding roller 211 and then via the feeding roller 211 and the pinch roller 212, documents is fed to the printing head 22 for printing. If it is not required to laminate any printed documents, these documents will be fed and placed into the first tray 24 via the second roller 23. If it does need to laminate the document, the feed roller 211 and the pinch roller 212 can rewind and carry the document, and the document can be moved in the direction of the sensor 13. Two gluey-film rollers 14, 15 are separately encased in these rolling gluey-films 141, 151. One of these rolling gluey-films 141, 151 at least has one or two film tapes with adhesive property, and causing the surface that has adhesive property to face outside. The sensor 13 is placed on the front of two gluey-film roller 14, 15 where the document is ready for feeding in. So the sensor 13 can monitor the status of the document of arrival, as well as the document of leave. The sensor 13 can be a mechanical structure for a press switch or a photosensitive structure of a switch. Two gluey-film rollers 14, 15 can drive gluey-films 141, 151 separately, and press these gluey-films 141, 151 flexibly, thus causing these gluey-films 141, 151 to bind together. Between these two gluey-films 141, 151, the document can be stuck together like a sandwich. Finally, the document which is cohered by these two gluey-films 141, 151 can be fed into the roller set 16. The movable cutlery set 17 includes a cutlery 171 and cutlery set 172. The cutlery 171 and cutlery set 172 is placed between the feed-in roller set 16 and the feed-out roller 18, which can cut off the laminating film 141, 151 of the laminating document. Laminated documents will via a feed-out roller 18 feed to the second tray 19 for keep.

The controller 30 electrically connects to a first roller 12, two gluey-film rollers 14, 15, a feed-in roller set 16, a feed-out roller set 18, a feed roller 211, a pinch roller 212, a driving motor of a second output roller 23, an electrical connecting sensor 13, a movable cutlery set 17 and a controller mechanism of the printing head 22. When the controller 30 detects the signal as the user presses the button. It laminates and prints through the controller's 30 automatic pulse routine start signal. It then starts the first roller 12, the feed-in roller 211, the pinch roller 212 and the driving motor of the second output roller 23. It causes the output roller 12 to turn the movable object and then move to the feed-in roller 211, then via the feed-in roller 211 and the pinch roller 212 to move to the printing head 22. The controller 30 starts the control mechanism of the printing head 22, it cause the printing head 22 to carry out printing operation to a document. The printed document via the second output roller 23 moves to the first tray 24. When the controller 30 detects the printing head 22 which already finishes the printing operation, the controller immediately sends out a control signal to reverse the second output roller 23, the feed-in roller 211 and the pinch roller 212. It causes the printed document to move in the direction of the detector 13. When the sensor 13 detects the front-end of a document which arrives a reaction area, it immediately sends out a signal. The controller 30 detects this signal and after a shorter period of time, it then immediately sends out a signal. To start the motor of the two gluey rollers 14, 15, the feed-in roller set 16 and the feed-out roller 18, and to cause two gluey-films 141, 151 to glue a small section of film together, it glues a document into a stack of two pieces like a sandwich. This document can be fed into the direction of the movable cutlery set 17 by the feed-in roller 16. When the sensor 13 detects the rear-end of a document which arrives the reaction area, it immediately sends out a signal. The controller 30 detects another signal and after a shorter period of time, it causes the rear-end of the document, which has a small section of the two cohered gluey-film 141, 151, to pass through a movable cutlery set 17. It immediately starts the controller mechanism of a movable cutlery set 17 and uses a cutlery 171 to cut off the two adhesive gluey-films 141, 151, and then the controller 30 sends out a control signal to stop the two gluey-film rollers 14, 15 and feed-in roller set 16 motor from turning. It also keeps the motor of the feed-out roller 18 set turning, until the laminated document is sent out from the feed-out roller set 18, and then moves it to the second tray 19. The said cohesive part of the two gluey-films 141, 151 for the front and rear end of the document is to enable documents enclosed completely into the two gluey-films 141, 151. It can provide a better protection to documents. The above-mentioned shorter period of time or another shorter period of time is to run a scheduled time which is controlled by a counting motor of a controller.

When if it only carries out a printing process and does not carry out a laminating operation, then it can cause the controller 30 to control the feed roller 211, the pinch roller 212 and the second output roller 23 not to rewind, and cause the printed document to be placed into the first tray 24.

When if it only carries out a printing process and does not carry out a laminating operation, the user can places documents to be laminated into the carrying tray 11. The controller 30 detects the signal as the user presses the button for starting the laminating operation. Then the controller 30 can control the first output roller 12, the feed roller 211 and the pinch roller 212 in which the document to be laminated can be sent to the printing head 22, but it does not carry out printing operation. And then it causes the document to be moved in the direction of the sensor 13, make the document carry out the above-mentioned laminating operation.

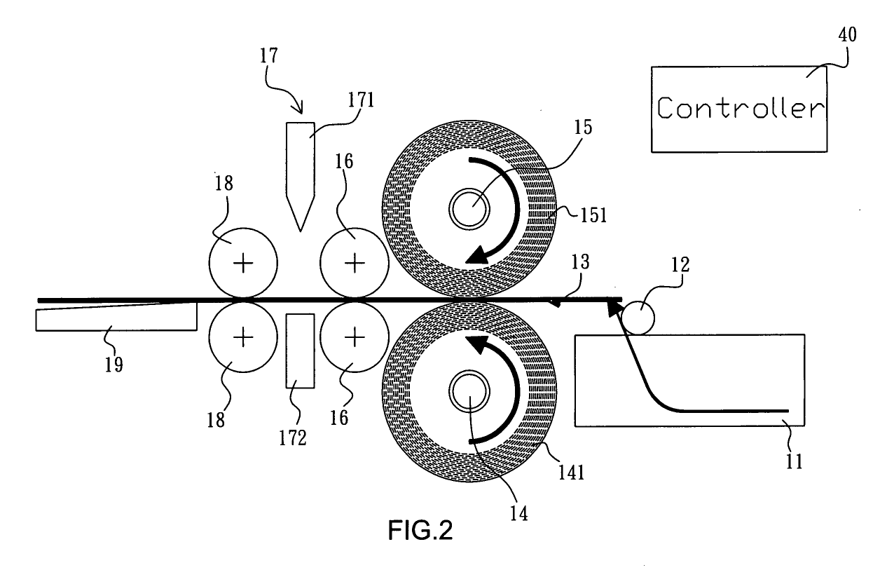

Please refer to FIG. 2, the present invention is provided with an adhesive laminating apparatus. It mainly not includes the printing apparatus which is show in the FIG. 1. This apparatus comprises a rack which connecting a carrying tray 11, a first output roller 12, a sensor 13, two gluey-film rollers 14, 15, a feed roller 16, a movable cutlery set 17, a feed-out roller 18, a tray 19 and a controller 40. The carrying tray 11 may contain the document, photo, a laminated sheet and such things that are to be printed. The first output roller 12 is coordinated with the carrying tray 11. When the first roller 12 is in operation, the document can be fed out from the carrying tray 11, fed into two gluey-film rollers 14, 15. Two gluey-film rollers 14, 15 are separately encased in these rolling gluey-films 141, 151. One of these rolling gluey-films 141, 151 at least has one or two film tapes with adhesive property, and causing the surface that has adhesive property to face outside. The sensor 13 is placed on the front of two gluey-film rollers 14, 15 where the document is ready for feeding in. So the sensor 13 can detect the status of the document of arrival, as well as the document of leave. The sensor 13 can be a mechanical structure for a press switch or a photosensitive structure of switch. Two gluey-film rollers 14, 15 can drive the gluey-films 141, 151 separately, and press these gluey-films 141, 151 flexibly, thus causing these gluey-films 141, 151 to bind together. Between these two gluey-films 141, 151, the document can be glued together like a sandwich. Finally, the document which is cohered by these two gluey-films 141, 151 can be fed into the roller set 16. The movable cutlery set 17 includes a cutlery 171 and a cutlery set 172. The cutlery 171 and cutlery set 172 is placed between the feed-in roller set 16 and the feed-out roller 18, in which the laminating film 141, 151 of the laminating document can be cut off by the cutlery 171. Laminated documents will via a feed-out roller 18 to feed to the second tray 19 for keep.

The controller 40 electrically connects to the first roller 12, two gluey-film rollers 14, 15, the feed-in roller set 16, a driving motor of the feed-out roller set 18, and electrical connecting the sensor 13, a controller mechanism of the movable cutlery set 17. When the controller 40 detects the signal as the user press the button, it laminates through the controller's 40 automatic pulse routine start signal. The controller 40 then starts the driving motor of the first roller 12. It causes the output roller 12 to turn the movable documents and then move in the direction of the sensor 13. When the sensor 13 detects the front-end of the document which arrives a reaction area, it immediately sends out a signal. The controller 40 detects this signal and after a shorter period of time, and then immediately sends out a signal. Now to start the motor of the two gluey rollers 14, 15, the feed-in roller set 16 and the driving motor of the feed-out roller set 18, and to cause two gluey-films 141, 151 to glue a small section of film together, then to glue a document into a stack of two pieces like a sandwich. This document can be fed into the direction of the movable cutlery set 17 by the fed-in roller 16. When the sensor 13 detects the rear-end of a document which arrives the reaction area, it immediately sends out a signal. The controller 40 detects another signal and after a shorter period of time, it causes the rear-end of the document, which has a small section of the two cohered gluey-films 141, 151, to pass through a movable cutlery set 17. It immediately starts the controller mechanism of the movable cutlery set 17 and uses a cutlery 171 to cut off the two adhesive gluey-films 141, 151, and then sends out a control signal to stop the two gluey-film rollers 14, 15 and the driving motor of the feed-in roller set 16 from turning. It also causes keep the motor of the feed-out roller set 18 turning, until the laminated document is sent out from the feed-out roller set 18, and then moves it to the second tray 19. The said the cohesive part of the two gluey-films 141, 151 for the front and rear end of the document is to enable documents enclosed completely into the two gluey-films 141, 151. It can provide a better protection to documents. The above-mentioned shorter period of time or another a shorter period of time is to run at a scheduled time which is controlled by a counting motor of the controller.

The present invention does not need manpower that can cause the document to be laminated and can be attached between opposing gluey-films. It is not restricted to the length of documents. It may depend on the length of the document automatically to cut off the gluey-film and carry out the automatic operation with adhesive laminating, thereby reducing the laminating film waste between documents, and improving productivity of the laminating operation.

The present invention directly uses an adhesive document with an adhesive-tape and gluey-film sandwich style. It is not necessary to use a heating apparatus and not necessary to wait until the roller has gotten hot. It can keep quality laminating film also from the burning problem that is caused by a careless user.

The present invention is to provide a printing apparatus with the adhesive laminating function. The printer can increase practical function and produce competitive strength.

The above described embodiments are for explaining technical concepts and features. Those skilled in the art will appreciate that with various modifications, substitution is possible, without departing from the scope of the inventions which are disclosed in the accompanying claims.

What is claimed is:

1. An adhesive laminating apparatus comprises a rack which connecting a sensor, two gluey-film rollers, a feeding-in roller set, a movable cutlery set, a feeding-out roller set and a controller in sequence; two gluey-film rollers are provided to bind a gluey-film, wherein these two gluey-films at least have an adhesive tape-gluey-film; the controller electrically connects to two gluey-film rollers, the feed-in roller set, the driving motor of the feed-out roller set, and electrically connects to the sensor, the controller mechanism of the cutlery set; when the sensor that detects the front-end of a document that to be laminated which arrives a reaction area, it immediately sends out a signal; the controller detects this signal and after a shorter period of time, it then immediately sends out a signal; to start the motor of the two gluey rollers, feed-in roller set and the motor of the feed-out roller, and to cause the feed-in roller set to drive the document which is glued by two gluey-films like a sandwich; these the document can be fed into the direction of the movable cutlery set; when the sensor detects the rear-end of the document which arrives the reaction area, it immediately sends out a signal; the controller detects another signal and after a shorter period of time, it immediately starts the controller mechanism of the movable cutlery set and uses a cutlery to cut off the two adhesive gluey-films and then sends out a control signal to stop the two gluey-film roller and feed-in roller set motor from turning; it also keeps the motor of the feed-out roller set turning, until the laminated document is sent out from the feed-out roller set.

2. The adhesive laminating apparatus according to claim 1, wherein the rack connects a carrying tray and an output roller, the controller electrically connects to the driving motor of the output roller; the carrying tray is to provide for containing the document that to be laminated; when the controller detects the signal which is to be carried out the laminating operation, the controller immediately starts a signal, and then starts the motor of the roller for operation; it causes the output roller to send the document and then to move in the direction of the detector.

3. The adhesive laminating apparatus according to claim 2, wherein the rack connects a tray, causing the laminated document to be sent out of the feed-out roller set, and then to be placed into the tray.

4. The adhesive laminating apparatus according to claim 3, wherein the movable cutlery set includes a cutlery and a cutlery block.

5. The adhesive laminating apparatus according to claim 4, wherein the controller detects the signal and after a shorter period of time, the controller then starts the motor of these two gluey-rollers, then causes these two gluey-films to glue a small section of film together, and then to glue a document into a stack of two pieces like a sandwich.

6. The adhesive laminating apparatus according to claim 5, wherein there is a shorter period of time that means the time period is for the rear-end of the document have a small section of two adhesive gluey-films to be passed through the cutlery set.

7. A printing apparatus with the adhesive laminating function, comprises a rack which connecting a carrying tray, a first output roller, a feed roller, a pinch roller, a printing head, a second output roller, a first tray, a sensor, two gluey-film rollers, a feed-in roller set, a movable cutlery set, a feed-out roller set and controller; these two gluey-films are to provide to separately bind a gluey-film, wherein these two gluey-films at least have an adhesive tape-gluey-film; the controller electrically connects to the first output roller, the feed-in roller, the pinch roller, the second output roller, two gluey-film rollers, the feed-in roller set, the driving motor of the feed-out roller set, the printing head of electrically connecting, the sensor and the controller mechanism of the cutlery set; it cause the controller to control the feed-in roller, the pinch roller, the driving motor of the second output roller, then causing the feed roller, the pinch roller, the second output-roller to drive the laminated document to move in the direction of the sensor; when the sensor that detects the front-end of a document that to be laminated which arrives a reaction area, it immediately sends out a signal; the controller detects this signal and after a shorter period of time, the controller then immediately sends out a signal; to start the motor of the two gluey rollers, the feed-in roller set and the feed-out roller, and to cause the feed-in roller set to drive the document which is glued by two gluey-films like a sandwich; this document can be fed into the direction of the movable cutlery set; when the sensor detects the rear-end of the document which arrives the reaction area, it immediately sends out a signal; the controller detects the another signal and after a shorter period of time, it immediately starts the controller mechanism of a movable cutlery set and uses a cutlery to cut off these two adhesive gluey-films and then sends out a control signal to stop these two gluey-film rollers and the motor of the feed-in roller set from turning; it also keeps the feed-out roller set motor turning, until the laminated document is sent out from the feed-out roller set.

8. The printing apparatus with the adhesive laminating function according to claim 7, wherein the carrying tray is to provide for containing the document that to be laminated; when the controller detects the signal which is to be carried out the laminating and printing operation, the controller immediately starts a signal, and then starts the first out-put roller, the feed-in roller, the pinch roller and the motor of the second output roller; it causes the output roller to drive the object to be moved to the feed-in roller, then causing the feed-in roller and the pinch roller to be moved to the printing head; the controller also starts the mechanism of the printing head and causes the printing head to carry out printing operation to a document; the printed document via the second output roller moves to the first tray; when the controller detects the printing head which already finishes the printing operation, the controller immediately sends out a control signal to rewind the second output roller, feed-in roller and pinch roller; it causes the printed document that to be laminated to move in the direction of the detector.

9. The printing apparatus with the adhesive laminating function according to claim 7, wherein the carrying tray is to provide for containing the document that to be laminated; when the controller detects the signal which is to be carried out the laminating operation, it immediately starts a control signal, and then starts the first out-put roller, the feed-in roller, the pinch roller and the motor of the second output roller; it causes the output roller to drive the object to be moved to the feed-in roller, then causing the feed-in roller and the pinch roller to be moved to the printing head; the controller also controls the mechanism of the printing head and inhibits the printing head to carry out printing operation; and then it causes the document that to be laminated to be moved in the direction of the sensor.

10. The printing apparatus with the adhesive laminating function according to claim 1, wherein the rack binds the second tray, it causes the laminated document to be sent out of the feed-out roller set, and then to be placed into the second tray.

11. The printing apparatus with the adhesive laminating function according to claim 10, wherein the movable cutlery set includes the cutlery and the cutlery block.

12. The printing apparatus with the adhesive laminating function according to claim 11, wherein the controller detects the signal and after a shorter period of time, it then starts the motor of two gluey-rollers for operation, then causes these two gluey-films to glue a small section of film together, and then to glue a document into a stack of two pieces like a sandwich.

13. The printing apparatus with the adhesive laminating function according to claim 12, wherein there is a shorter period of time that means the time period is for the rear-end of the document have a small section of two adhesive gluey-films to be passed through the cutlery set.
